(19) United States
(12) Patent Application Publication
(10) Pub. No.: US 2011/0217409 A1
(43) Pub. Date: Sep. 8, 2011

(54) COMPOSITE STAMP FOR EMBOSSING

(76) Inventors: John Christopher Rudin, Bristol (GB); Stephen Kitson, Bristol (GB); Timothy Taphouse, Bristol (GB); David Alexander Pearson, Monmouth (GB)

(21) Appl. No.: 13/125,716

(22) PCT Filed: Oct. 28, 2008
(86) PCT No.: PCT/EP08/64600

§ 371 Date: Apr. 22, 2011

(51) Int. Cl. B29C 59/02; B32B 37/12; C25D 1/10

(52) U.S. Cl. 425/470; 156/151; 205/70

(57) ABSTRACT

A method of manufacturing a composite stamp (24) for embossing comprises the steps of:
(a) taking a master structure (10) having a conductive surface (16) and dielectric features (18) thereon;
(b) depositing an opaque material on exposed regions of the conductive surface (16) to form an opaque mask (20);
(c) coating the dielectric features (18) and opaque mask (20) with a fluid material (4) which is capable of being transformed to a form-retaining material;
(d) causing or permitting the fluid material (4) to be transformed to a form-retaining material which is bonded to the opaque mask (20); and
(e) removing the form-retaining material (4) and bonded opaque mask (20) from the master structure (10) to provide the composite stamp (24).

Other aspect of the invention provide a composite stamp (24) and a composite structure (22) for making the composite stamp.

### BACKGROUND

In microreplication, particularly for the formation of ‘circuits’ by subsequent electroforming and transfer from an original conductive carrier (e.g. in WO 2005/091061), it is desirable to minimise or completely avoid any cured residual material underneath the ‘lowest’ feature on the embossing stamp. For example in systems using UV radiative curing of a polymer whilst a transparent ‘stamp’ is in situ, the thickness of the residual layer is typically reduced, but not eliminated, by the application of significant pressure as shown in FIG. 1. In the prior art embossing process shown in FIG. 1, a substrate 8 is coated with a layer of curable embossing resin 6. A stamp comprising a transparent stamp substrate 2 and a moulded stamp relief layer 4 is applied to the resin layer 6 and UV radiation and pressure are applied. The resin 6 is cured to have a complementary shape to the moulded stamp relief 4. However, typically an undesired residual layer 6a of resin remains under the farthest-projecting features of the stamp relief layer 4, despite the applied pressure. For example, in the graph of the profile of a dielectric resin formed according to the prior art, shown in FIG. 8, a residual layer of 50-200 nm thickness remains. This residual layer 6a may need to be removed in a further process step.

U.S. Pat. No. 4,543,225 describes a system whereby the curing of the thicker regions is preferred (faster) than the thin regions. This is achieved by making the taller features on the stamp opaque, or semi opaque. The result is that the formation of the residual layer is avoided. The patent does not detail how such a stamp could be practically made.

There are two specific applications where this technique is advantageous: firstly where the emboss is to be used for the formation of a circuit by subsequent electroforming. No material should remain at the bottoms of the embossed ‘trenches’ and typically an oxygen plasma, UV-Ozone or Excimer laser ash-back step is required. This step is costly in production and can lead to channel widening, loss of aspect ratio in the entire surface relief, and potentially undesirable modification of the surface chemistry. Secondly, for microrelief which is used for optical or liquid crystal alignment applications, the thickness of the residual layer can lead to undesired optical and electric field changes which can be variable over the imprint area.

The prior art contains no details of any method to form the stamp, excepting that the opaque metal might be chromium or titanium, or a modified glass, which would indicate fabrication by sputter deposition and subsequent standard lithographic patterning.

There is considerable prior art in UV micromoulding in either continuous or single imprint modes. Generally the control of the residual layer is seen as a problem and overcome by higher ‘nip’ pressures and process speed.

Composite imprinting stamps where the stamp comprises parts with different compliances is known in the prior art (e.g. US 2005/0133954). No reference has been found for a similar means for fabricating composite (optical and surface relief) stamps.

Aspects of the present invention are specified in the independent claims. Preferred features are specified in the dependent claims.

An advantage of the present invention is the ability to form the opaque regions of the stamp in a completely self-aligned and repeatable fashion from an original master which is left intact. This is achieved using a process which is compatible with previous technology, and still allows for multilevel and complex surface relief patterns to be formed. The invention allows multiple stamps to be easily fabricated from a master structure, where the tallest parts have a metallised or opaque portion which is largely opaque to UV illumination.

The terms ‘electroforming’ and ‘electro-depositing’, and related terms, are synonymous and are used interchangeably herein. The terms ‘stamp’, ‘shim’ and ‘die’ are also synonymous and are used interchangeably herein. The terms ‘embossing’ and ‘imprinting’ are synonymous and used interchangeably herein.

### BRIEF DESCRIPTION OF THE DRAWINGS

The invention will now be further described, by way of example only, with reference to the following drawings in which:

FIG. 1 is a schematic sectional view of a prior art embossing process;

FIGS. 2-6 show stages in the manufacture of a composite stamp for embossing in accordance with an embodiment of the present invention;

FIG. 7 is a schematic diagram of steps in a process for manufacturing a composite stamp in accordance with an embodiment of the present invention; and

FIGS. 8 and 9 are graphs of profiles of dielectric resin in a trench of an embossed product made in accordance with, respectively, the prior art and an embodiment of the present invention.

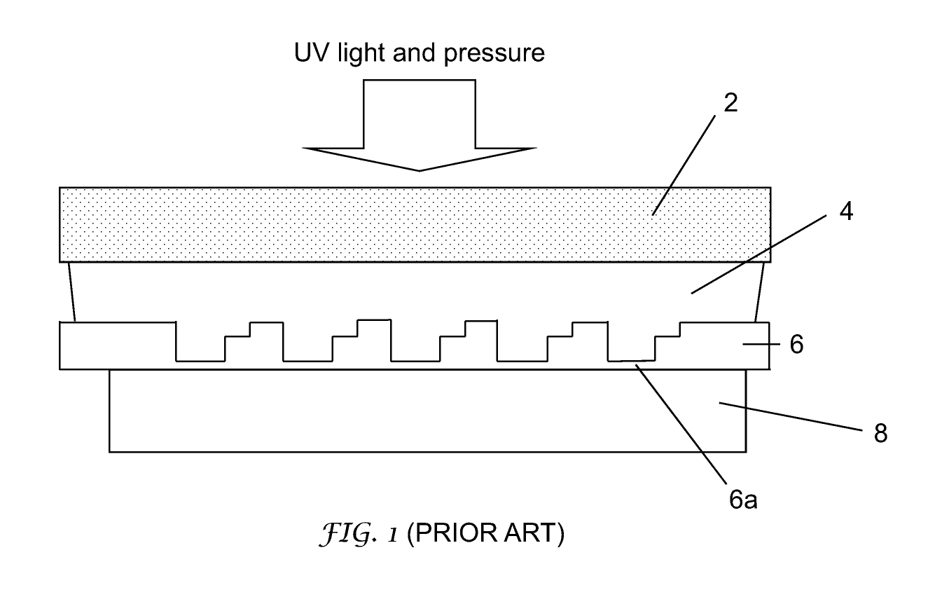

### DETAILED DESCRIPTION

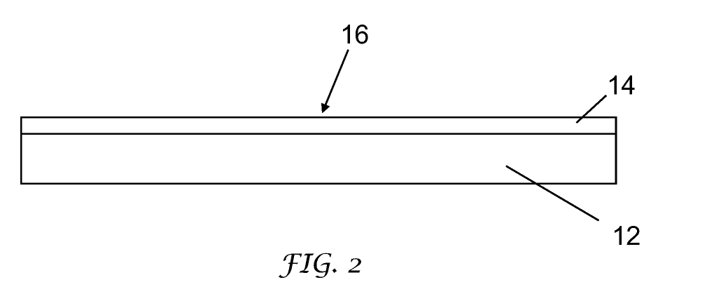

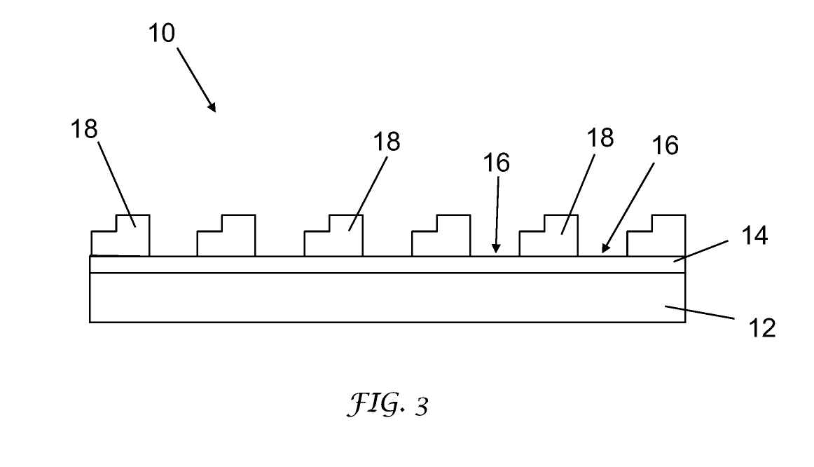

The conductive carrier shown in FIG. 2 comprises a support layer 12 with a conductive coating 14. In this embodiment the conductive surface 16 of the coating 14 is substantially planar. Referring to FIG. 3, dielectric features 18 are formed on the conductive surface 16 using standard photolithography or other means, such that the lowest parts of the eventual imprint correspond to exposed conductive regions 16. The conductive carrier with the dielectric features 18 provides a master structure 10 which can be used to fabricate a series of composite stamps.

In a first implementation example the support layer 12 is a glass substrate of 1.1 mm thickness, the conductive coating 14 is 30 nm of Cr followed by 250 nm of Stainless Steel sputter coated. The dielectric features 18 are formed from SU8-2000 (MicroChem Corp). UV (i-line) lithography is used to define the pattern, and the resulting structures are fully cured by baking at 140° C. for 30 minutes. The conductive surface 16 is formed, or treated, such that a subsequently electroformed metal will release from the carrier metal.

In a first implementation the treatment consists of immersion in 0.1N potassium dichromate solution for 5 minutes followed by a deionized water rinse and drying, in a manner well known in the art per se.

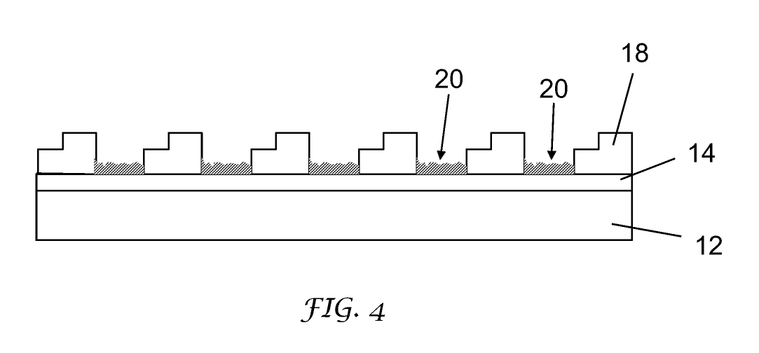

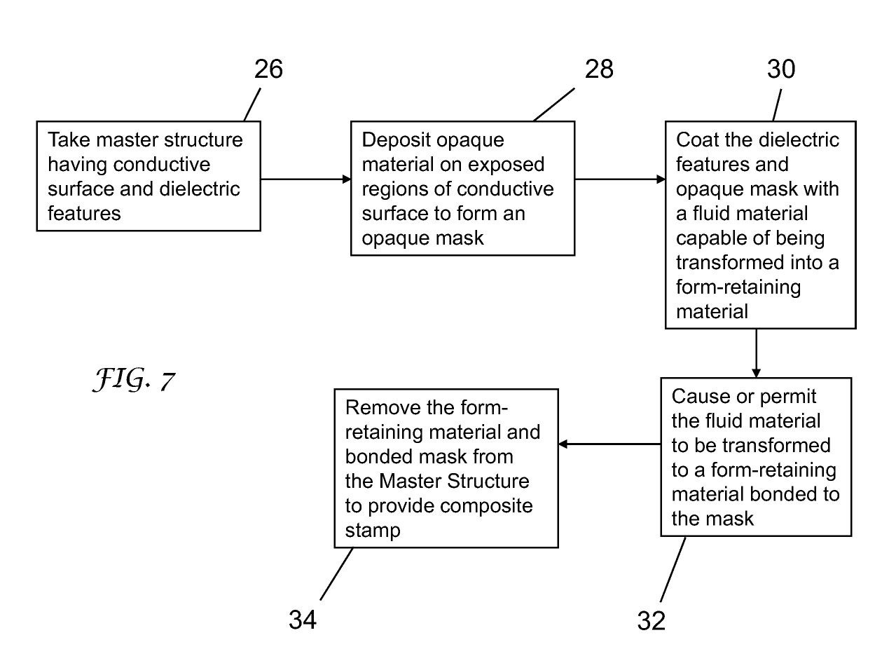

The master structure 10 is taken [process step 26, FIG. 7] and a thin (−500 nm) layer of an opaque material is electro-deposited (FIG. 4) on exposed regions of the conductive surfaces 16. In this embodiment the opaque material is a metal; however it will be understood that other opaque materials may be used providing that these are capable of being electro-deposited. For convenience the invention will be described with reference to the opaque material being a metal. Non-limiting examples of suitable metals include: nickel, copper, gold, and chromium. The electro-deposited metal forms an opaque mask 20, in this embodiment, a metal mask [process step 28]. The exposed metal surface is ideally rough and can be treated with an adhesion promoter if necessary.

In a first implementation a thin layer of nickel is electrodeposited from a standard nickel sulphamate plating bath with the conductive surfaces 16 forming the cathode.

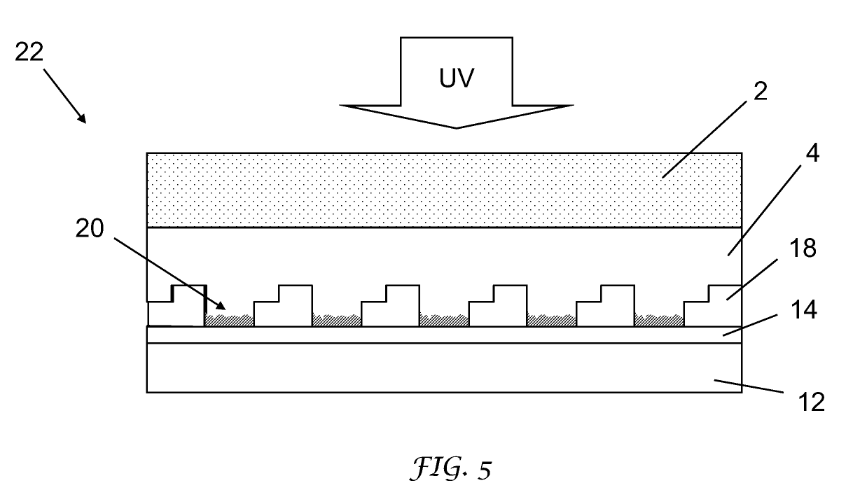

Referring now to FIG. 5, a relatively thick layer of a fluid material 4 which is capable of being transformed into a form-retaining material, is applied so as to coat the dielectric features 18 and the metal mask 20 [process step 30]. In this example, the fluid material 4 is radiation-curable resin, in this example a UV-curable resin. The invention will, for convenience, be illustrated with reference to the use of a radiation-curable resin. However, it will be understood that alternative fluid materials may be used, which are capable of being transformed into form-retaining materials, for example: thermal-curing resins, thermoplastic materials, and reactive mixtures, typically containing one or more monomer or oligomer species, such as epoxy resins. It will be understood that the term ‘form-retaining material’ is used to denote a material which is sufficiently rigid to function as part of an embossing stamp. The form-retaining material in this example is a cured structure, but could alternatively be a thermoplastic material or a cross-linked material or other solid material formed from a fluid reactive mixture.

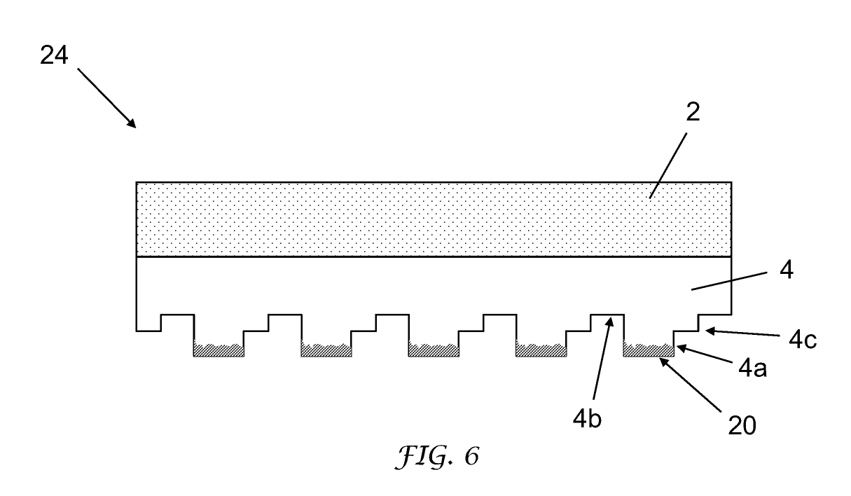

The fluid material may contain metal specific adhesion promoters, and surface release (slip) components to aid adhesion to the electro-deposited metal and release from the mastering surface. A stamp substrate 2 in this embodiment is laminated or otherwise bonded on the resin 4. The resin is cured by UV exposure through the stamp substrate 2 and/or thermal processing, to form a form-retaining material bonded to the mask 20 [process step 32]. Alternatively a thermoplastic material can be laminated at elevated temperatures to adhere to the metal features and take up the surface relief topography. The whole structure 4, including the metal material 20 at the bottom of the exposed features, is removed by peeling the stamp substrate 2 away from the master structure 10 to provide the composite stamp 24 (FIG. 6, process step 34). The master structure 10 is left intact and can be reused many times to form identical stamp structures 24.

In a first implementation the dielectric surface of the master is treated by coating with 0.1% OTMS (octyltrimethoxysilane) or OTS (octadecyltrichlorosilane) to effect a release coating. The curable resin 4 is UV curable adhesive NOA81 (Norland Products), and the stamp substrate is PET (ST506 from Dupont Teijin Films). The resin is cured by UV exposure, and baking at 85° C. for 1 hour.

The composite stamp 24 in this embodiment comprises the stamp substrate 2 having the cured resin 4 on a surface thereof, the resin 4 including projecting regions 4a that extend farther from the stamp substrate than any other regions 4b,4c, wherein each projecting region 4a is capped by a metal layer 20. In this embodiment, the cured resin 4 has step structures 4c which are intermediate the closest regions 4b and the farthest region 4a. However, because of the method of manufacture, only the farthest extending projecting region 4a has the metal cap 20.

The stamp 24 thus produced may be used to produce embossed structures following the techniques as taught by U.S. Pat. No. 4,543,225, and can itself be used many times.

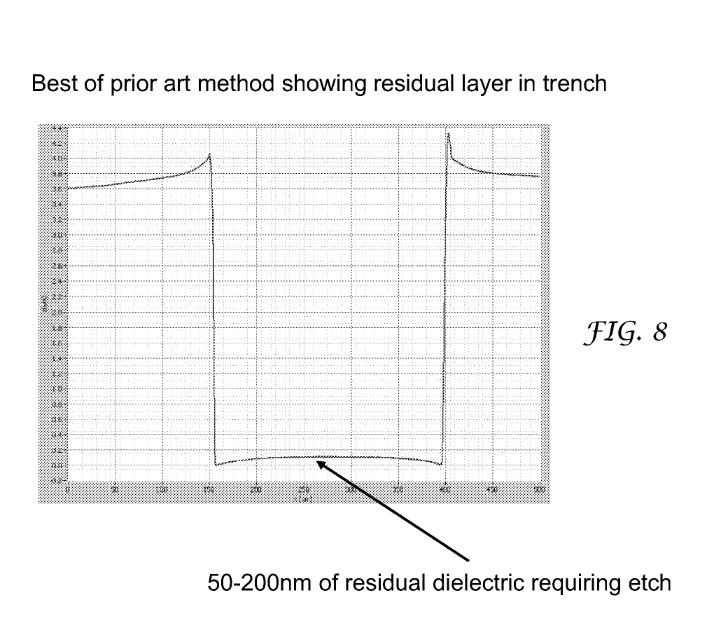

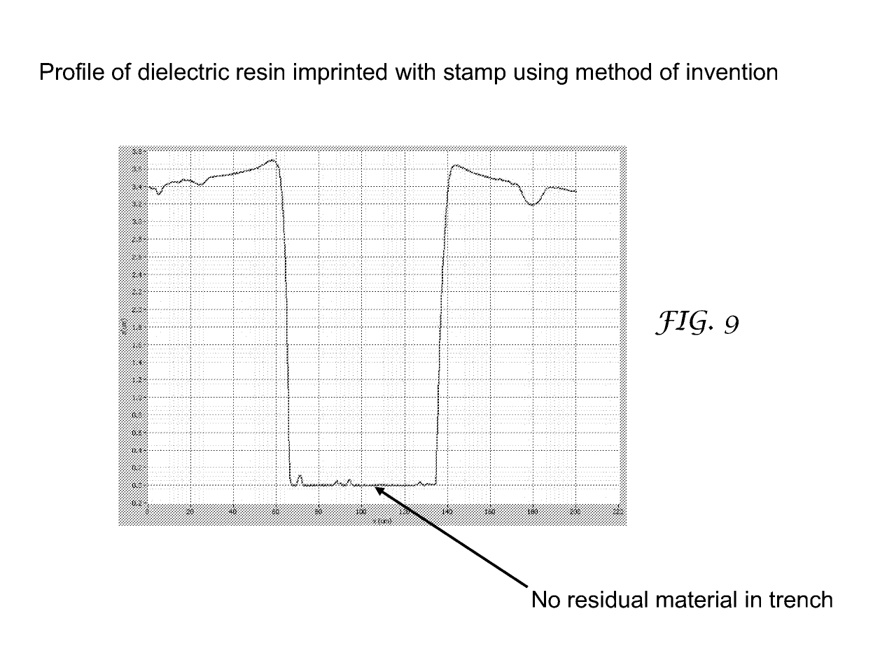

The profile of a dielectric resin imprinted with a stamp 24 produced in accordance with an embodiment of the present invention, after solvent rinsing to remove uncured material, is shown in FIG. 9. In contrast with the profile from the prior art process shown in FIG. 8 after rinsing to remove uncured resin material, substantially no residual material remains in the trench.

What is claimed is:

1. A method of manufacturing a composite stamp for embossing, the method comprising the steps of:
(a) taking a master structure having a conductive surface and dielectric features thereon;
(b) electro-depositing an opaque material on exposed regions of the conductive surface to form an opaque mask;
(c) coating the dielectric features and opaque mask with a fluid material that is capable of being transformed into a form-retaining material;
(d) causing or permitting the fluid material to be transformed to a form-retaining material which is bonded to the opaque mask; and
(e) removing the form-retaining material and bonded opaque mask from the master structure to provide the composite stamp.

2. A method according to claim 1, wherein the fluid material is a radiation-curable resin, a thermal-curable resin, a molten thermoplastic material, or a reactive mixture.

3. A method according to claim 1, further comprising bonding a stamp substrate to the fluid material before step (d).

4. A method according to claim 1, wherein the fluid material is a radiation-curable resin, the method further comprising bonding a stamp substrate to the fluid material before step (d), wherein curing of the resin is effected by illuminating the resin with suitable radiation through the stamp substrate.

5. A method according to claim 1, wherein the conductive surface of the master structure is treated with a release agent to promote release of the subsequently-deposited opaque material.

6. A method according to claim 1, further comprising the step of treating exposed surfaces of the deposited opaque material with an adhesion promoter to promote adhesion to the form-retaining material.

7. A method according to claim 1, wherein the opaque material is a metal.

8. A method according to claim 7, wherein the metal is selected from: nickel, copper, gold, chromium.

9. A method according to claim 1, wherein the opaque mask is about 50-700 nm thick.

10. A method according to claim 9, wherein the opaque mask is about 500 nm thick.

11. A method according to claim 1, wherein the master structure is manufactured by taking a support layer having a conductive coating on a major surface thereof, and forming the dielectric features by photolithography, laser processing, direct machining or micromoulding.

12. A method of manufacturing a composite stamp for embossing, the method comprising the steps of:
(a) taking a master structure having a conductive surface and dielectric features thereon;
(b) electro-depositing a metal on exposed regions of the conductive surface to form a metal mask;
(c) coating the dielectric features and metal mask with a fluid material that is capable of being transformed into a form-retaining material;
(d) causing or permitting the fluid material to be transformed to a form-retaining material which is bonded to the metal mask; and
(e) removing the form-retaining material and bonded metal mask from the master structure to provide the composite stamp.

13. A composite stamp for embossing, the stamp comprising a stamp substrate having a cured resin or thermoplastic material on a surface thereof, the cured resin or thermoplastic material including projecting regions that extend farther from the stamp substrate than any other regions, wherein each projecting region is capped by an opaque layer.

14. A stamp according to claim 12, wherein the opaque layer is from about 50 nm to about 700 nm thick.

15. A composite structure for making a composite stamp for embossing, the composite structure comprising:
(a) a master structure comprising a support layer having a conductive surface and dielectric features thereon;
(b) an opaque mask on the conductive surface adjacent to the dielectric features;
(c) a form-retaining layer of a cured resin or thermoplastic material on the opaque mask and the dielectric features; and
(d) a stamp substrate bonded to the form-retaining layer; wherein
(e) the opaque mask is bonded more strongly to the form-retaining layer than it is to the conductive surface; and
(f) the dielectric features are bonded more strongly to the conductive surface than to the form-retaining layer.

16. A composite structure according to claim 15, wherein the opaque mask is from about 50 nm to about 700 nm thick.

17. A composite structure according to claim 15, wherein the opaque mask is about 500 nm thick.
